(19) United States
(12) Patent Application Publication
(10) Pub. No.: US 2026/0341259 A1
(43) Pub. Date: Oct. 29, 2026

(54) VEHICLE ACTIVE NOISE CONTROL SYSTEM

(71) Applicants: Hyundai Motor Company, Seoul (KR); Kia Corporation, Seoul (KR)

(72) Inventor: Jea Kwan KIM, HWASEONG-SI (KR)

(73) Assignees: Hyundai Motor Company, Seoul (KR); Kia Corporation, Seoul (KR)

(21) Appl. No.: 19/363,396

(22) Filed: Oct. 20, 2025

(30) Foreign Application Priority Data
Apr. 23, 2025 (KR) 10-2025-0053215

(51) Int. Cl. G10K 11/178

(52) U.S. Cl. CPC G10K 11/17817; G10K 11/17823; G10K 11/17825; G10K 11/17883; G10K 2210/12821; G10K 2210/3022; G10K 2210/3026; G10K 2210/3027; G10K 2210/3028; G10K 2210/3035; G10K 2210/3052; G10K 2210/501

(57) ABSTRACT

A vehicle active noise control system includes a provisional virtual microphone path model generated by modeling a path from a specific error microphone, which is one of normal error microphones located around an abnormal error microphone, to a target position corresponding to the abnormal error microphone, and a control unit. The control unit is configured to generate control sound for a virtual microphone corresponding to the abnormal error microphone by use of a signal of the specific error microphone and the provisional virtual microphone path model, based on determination that the abnormal error microphone is abnormal.

### CROSS-REFERENCE TO RELATED APPLICATION

The present application claims priority from Korean Patent Application No. 10-2025-0053215 filed on Apr. 23, 2025, the present disclosure of which is incorporated herein by reference in its entirety.

### BACKGROUND OF THE PRESENT DISCLOSURE

### Field of the Present Disclosure

The present disclosure relates to a vehicle active noise control system.

### Description of Related Art

In recent years, there is an increasing trend toward application of technology that actively cancels driving noise of a vehicle, thereby significantly reducing noise inside the vehicle.

A vehicle active noise control system is configured to detect noise from an engine or road surface and generate control sound through speakers that can cancel noise received near to the ears of occupants.

To detect an error, which is the sum of the noise received near to the ears of the occupants and the control sound generated by the speakers, the vehicle active noise control system is equipped with error microphones near to the ears of the occupants. Generally, a plurality of error microphones, typically twice the number of occupants, are installed in the roof or headlining of the vehicle.

The above matters disclosed in the present section are merely for enhancement of understanding of the general background of the present disclosure and should not be taken as an acknowledgement or any form of suggestion that the matters form the related art already known to a person skilled in the art.

### BRIEF SUMMARY

Therefore, the present disclosure has been made in view of the above problems, and it is an object of the present disclosure to provide a vehicle active noise control system that enables continuous implementation of noise reduction functions by utilizing the remaining normal error microphones even when some of the numerous error microphones equipped in the vehicle malfunction, enhancing the marketability of the vehicle and avoiding excessive costs and time for vehicle maintenance.

The technical objects to be achieved by the present disclosure are not limited to the technical objects mentioned above, and other technical objects not mentioned will be clearly understood by a person having ordinary skill in the art to which the present disclosure pertains from the following description.

In accordance with an aspect of the present disclosure, to achieve the above objects, there is provided a vehicle active noise control system including: a provisional virtual microphone path model generated by modeling a path from a specific error microphone, which is one of normal error microphones located around an abnormal error microphone, to a target position, which is a virtual microphone position corresponding to the abnormal error microphone; and a control unit generating a control sound for a virtual microphone corresponding to the abnormal error microphone by use of a signal of the specific error microphone and the provisional virtual microphone path model, based on determination that the abnormal error microphone is abnormal.

The control unit may be configured to replace an actual secondary path model generated by modeling a path from a speaker to the abnormal error microphone with a borrowed secondary path model, which is an actual secondary path model generated by modeling a path from the speaker to the specific error microphone, based on determination that the abnormal error microphone is abnormal.

The control unit may be configured to generate an estimated primary noise signal at a position of the specific error microphone by use of the signal of the specific error microphone and an estimated control sound signal generated by applying a control sound signal provided to the speaker to the borrowed secondary path model.

The control unit may be configured to transform the estimated primary noise signal at the position of the specific error microphone into an estimated primary noise signal at the target position by applying the estimated primary noise signal at the position of the specific error microphone to the provisional virtual microphone path model.

The control unit may be configured to generate an estimated error signal at the target position by use of the estimated primary noise signal at the target position and a control sound signal at the target position.

The control sound signal at the target position may be generated by applying a control sound signal provided to the speaker to a virtual secondary path model generated by modeling a path from the speaker to the target position.

The control sound signal provided to the speaker may be configured to be generated by an adaptive control filter using a reference signal for a noise source, a signal obtained by applying the reference signal to the virtual secondary path model, and the estimated error signal at the target position.

The reference signal for the noise source may be a signal from an accelerometer disposed on a vehicle body of the vehicle.

The specific error microphone may be a normally operating error microphone, which forms a pair with the abnormal error microphone, and may be one of error microphones respectively disposed around both ears of the same occupant.

The vehicle active noise control system may further include a storage unit configured to store the provisional virtual microphone path model.

In various aspects of the present disclosure, even when some of the numerous error microphones equipped in the vehicle malfunction, noise reduction functions may be continuously implemented by utilizing the remaining normal error microphones, enhancing the marketability of the vehicle and avoiding excessive costs and time for vehicle maintenance.

Various effects and advantages other than those mentioned above may be derived from the description below and will be clearly understood by a person including ordinary skill in the art to which the present disclosure pertains.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view exemplarily illustrating a vehicle active noise control system according to an exemplary embodiment of the present disclosure;

FIG. 2 is a view explaining an actual secondary path, a virtual secondary path, and a virtual microphone path;

FIG. 3 is a view explaining occupants, error microphones, and virtual microphone paths in a state where all error microphones are normal;

FIG. 4 is a view exemplarily illustrating the vehicle active noise control system according to an exemplary embodiment of the present disclosure in a state where all error microphones disposed in the headlining of the driver's seat in FIG. 3 are normal;

FIG. 5 is a view explaining, in comparison with FIG. 3, replacement with a specific error microphone and a provisional virtual microphone path according to an exemplary embodiment of the present disclosure when some error microphones are determined to be abnormal due to malfunction;

FIG. 6 is a view exemplarily illustrating the vehicle active noise control system according to an exemplary embodiment of the present disclosure in a state where the left error microphone among the error microphones disposed in the headlining of the driver's seat in FIG. 3 is malfunctioning; and

FIG. 7 is a flowchart exemplifying an exemplary embodiment of a vehicle active noise control method according to an exemplary embodiment of the present disclosure.

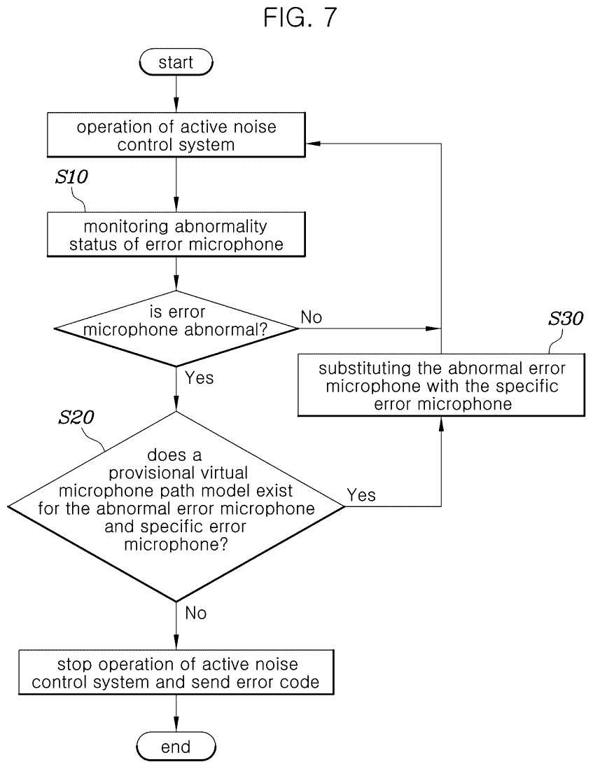

### DETAILED DESCRIPTION

Hereinafter, various exemplary embodiments of the present disclosure will be described in detail with reference to the accompanying drawings. In describing the exemplary embodiments of the present disclosure, detailed descriptions of related known technologies will be omitted if they are deemed to obscure the gist of the present disclosure. Furthermore, the drawings are merely provided to facilitate understanding of the exemplary embodiments disclosed in the present specification and should not be construed as limiting the technical concept disclosed in the present specification. The technical concept disclosed in the present specification should be understood to include all changes, equivalents, and substitutes included in the spirit and scope of the present disclosure.

Terms including ordinals such as “first”, “second”, etc. may be used to describe various components, but the components should not be limited by the terms. The terms are used only for the purpose of distinguishing one component from other components.

Singular forms are intended to include plural forms unless the context clearly indicates otherwise.

In the present specification, terms such as “include” or “have” are used to specify the presence of stated features, numbers, steps, operations, components, parts, or a combination thereof, but do not preclude the presence or addition of one or more other features, numbers, steps, operations, components, parts, or a combination thereof.

In the following description, suffixes “module” and “unit” for components are used for convenience of description and do not have different meanings or roles by themselves.

When a component is referred to as being “connected to” or “coupled to” another component, it may be directly connected to or coupled to the other component, but it should be understood that there may be another component in between. On the contrary, when a component is referred to as being “directly connected to” or “directly coupled to” another component, it should be understood that there is no other component in between.

Additionally, the term “Unit” or “Control Unit” included in the name is a term widely used in naming control devices (Controllers) that control specific functions of a vehicle, not to be understood as a Generic function unit.

A controller may include a communication device for communicating with other controllers or sensors for the control of the function it is responsible for, a memory for storing an operating system, logic instructions, and input/output information, and one or more processors for performing judgment, calculation, decision, etc. required for controlling the function.

It should be understood that any number of components or various components may be included in any of the configurations described in the present specification. The components may include any combination of features described in the present specification and may be arranged in any of the various configurations described in the present specification. The concepts regarding the structure and arrangement of the components of the present disclosure, as well as their use and operation, may be applied to any number of embodiments, not only the specific embodiments discussed in the present specification. Various arrangements with various features of the various embodiments including those will be described below with reference to the drawings.

Hereinafter, various embodiments disclosed in the present specification will be described in detail with reference to the accompanying drawings, wherein like reference numerals designate like or similar components regardless of the reference numerals in the drawings, and redundant description thereof will be omitted.

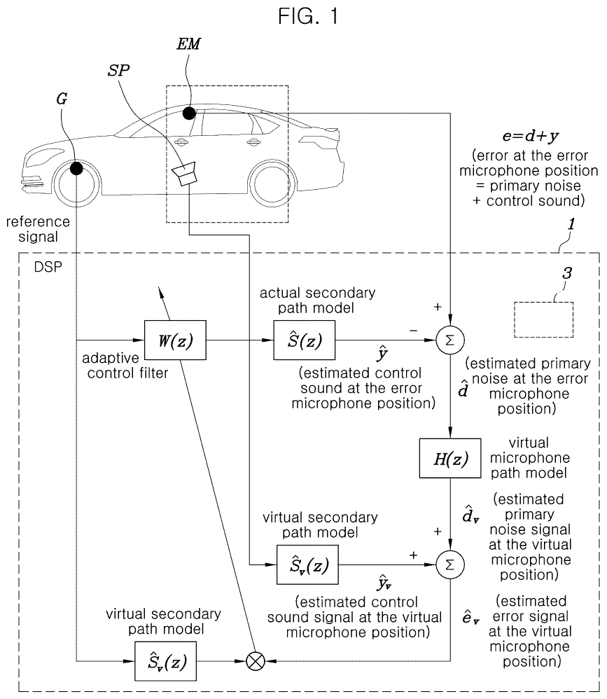

Referring to FIG. 1, the vehicle active noise control system according to an exemplary embodiment of the present disclosure obtains a reference signal from a noise source of a vehicle through an accelerometer G, etc., applies the reference signal to an adaptive control filter W(z), and provides a control sound signal generated thereby to a speaker SP to generate control sound y, being configured to cancel noise input to the ears of occupants.

To appropriately cancel the noise input to the ears of occupants, it is necessary to know the error e, which is represented as the sum of the primary noise d input to the ears of occupants and the control sound y. For the present purpose, the system is disposed with an error microphone EM near to the ears of the occupants to measure the error e.

Ideally, it would be desirable to equip the error microphone EM at the ear position of the occupants and detect the error through the error microphone EM, but this may be difficult or rather inconvenient for the occupants in reality. Therefore, in an exemplary embodiment of the present disclosure, the error microphone EM is disposed in the vehicle's roof or headlining adjacent to the occupant's ears, and it is assumed that a virtual microphone is disposed at the ear position of the occupants. The system is configured to generate the control sound signal using an estimated error that is estimated to be measured at the virtual microphone.

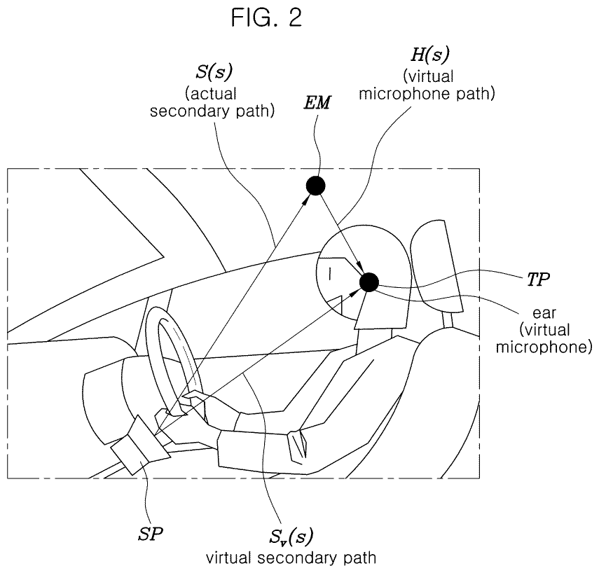

Referring to FIG. 2 together, the path from the speaker SP to the error microphone EM is defined as the actual secondary path S(s), the path from the speaker SP to the ear (virtual microphone) of the occupant is defined as the virtual secondary path Sᵥ(s), and the path from the error microphone EM to the virtual microphone TP is defined as the virtual microphone path H(s).

For reference, the expression “secondary path” is a term used to distinguish from the “primary path,” which is the path through which noise generated from the noise source travels through the air and reaches the error microphone EM or ear.

The actual secondary path S(s), virtual secondary path Sᵥ(s), and virtual microphone path H(s) may be approximated by modeling into an actual secondary path model Ŝ(z), a virtual secondary path model Ŝᵥ(z), and a virtual microphone path model H(z), respectively, which may be stored in a control unit 1 such as a DSP (Digital Signal Processor).

For example, the actual secondary path model Ŝ(z) may be viewed as an approximation of various physical factors into a single filter, including time delay, attenuation, distortion due to the frequency characteristics of the speaker SP or error microphone EM, and distortion due to reflection or diffraction in the air, that may affect the control sound y generated from the speaker SP as it is received by the error microphone EM.

Similarly, the virtual secondary path model Ŝᵥ(z) is an approximation of various physical factors that may affect the control sound y as it is transmitted from the speaker SP to the ear of the occupant into a single filter, and the virtual microphone path model H(z) is an approximation of various physical factors that may affect the noise at the error microphone EM position as it is transmitted to the virtual microphone along the virtual microphone path H(s) into a single filter.

Therefore, by applying the control sound y generated from the speaker SP to the actual secondary path model Ŝ(z), the estimated control sound ŷ at the error microphone EM position may be obtained.

Meanwhile, the error microphone EM receives the error e, which is the remaining noise that cancels the primary noise d input from the noise source to the error microphone through the primary path, plus the control sound y transmitted from the speaker SP through the actual secondary path.

By subtracting the estimated control sound ŷ signal at the error microphone EM position, which is obtained by applying the control sound signal provided to the speaker SP to the actual secondary path model Ŝ(z), from the error e received at the error microphone EM, the estimated primary noise \hat{d} signal at the error microphone EM position may be obtained.

By applying the estimated primary noise \hat{d} signal at the error microphone EM position to the virtual microphone path model H(z), the estimated primary noise \hat{d}ᵥ signal at the virtual microphone position may be obtained.

That is, the estimated primary noise \hat{d}ᵥ signal that is estimated to be heard at the ear of the occupant may be obtained.

By adding the estimated control sound ŷᵥ signal at the virtual microphone position, which is obtained by applying the control sound signal provided to the speaker SP to the virtual secondary path model Ŝᵥ(z), to the estimated primary noise \hat{d}ᵥ signal at the virtual microphone position, the estimated error êᵥ signal at the virtual microphone position may be obtained.

The control sound signal provided to the speaker SP is generated by an adaptive control filter W(z) using a reference signal for the noise source, a signal obtained by applying the reference signal to the virtual secondary path model Ŝᵥ(z), and the estimated error êᵥ signal at the virtual microphone position.

The adaptive control filter W(z) may be configured to update the filter coefficients in real-time based on the FxLMS (Filtered-x Least Mean Square) algorithm.

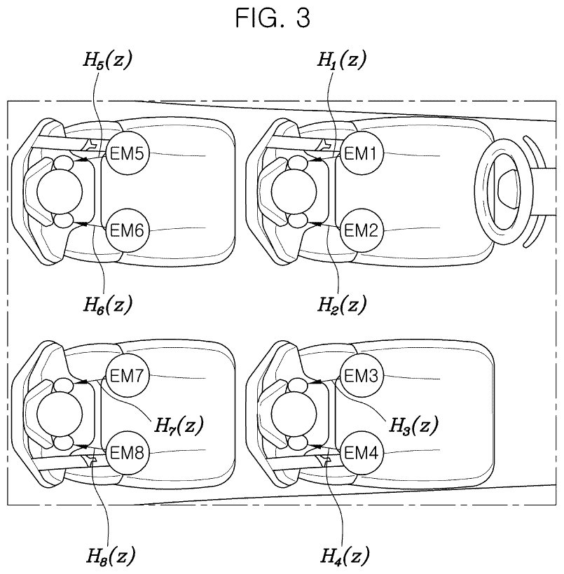

The vehicle active noise control system according to an exemplary embodiment of the present disclosure, as shown in FIG. 3, is disposed with error microphones EM near to each of the occupant's ears, and has virtual microphone path models H₁(z), H₂(z), . . . H₈(z) from each error microphone EM to the occupant's ear. Using these, the system is configured to continuously generate control sound signals to the speaker SP in the manner described above to maximize the cancellation of noise at the occupant's ears.

For reference, the subscript numbers in the virtual microphone path models are used to distinguish between multiple pairs of error microphones and virtual microphones. For example, H₁(z) refers to the virtual microphone path model between the error microphone EM1 near to the left ear of the driver's seat and the left ear of the driver, and H₂(z) refers to the virtual microphone path model between the error microphone EM2 near to the right ear of the driver's seat and the right ear of the driver.

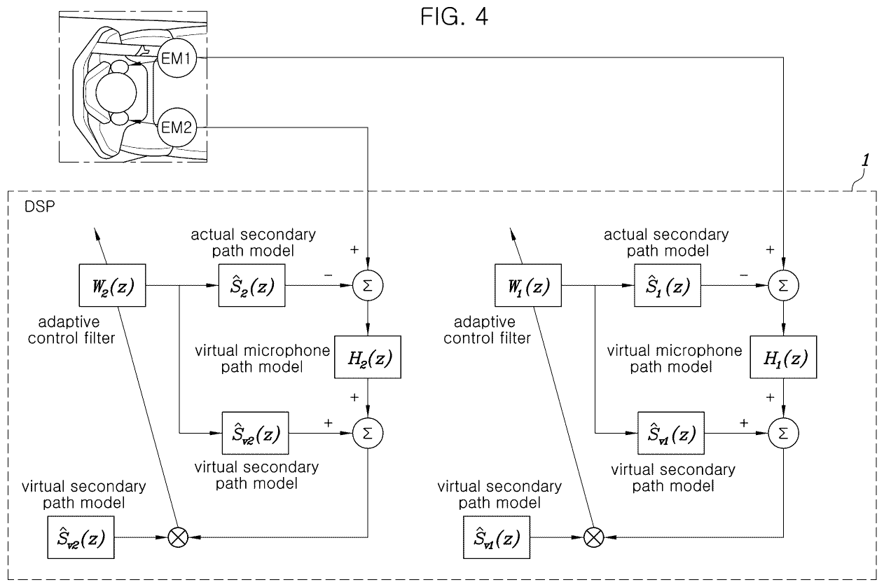

FIG. 4 explains the vehicle active noise control system according to an exemplary embodiment of the present disclosure in a state where all error microphones EM disposed in the headlining of the driver's seat in FIG. 3 are normal.

That is, each of the left and right error microphones EM1, EM2 of the occupant forms an individual active noise control system that generates control sound signals to be generated by the speaker SP using models and an adaptive control filter as shown in FIG. 1.

Here, the speaker SP may be configured as the same speaker SP, or it may be configured as individually disposed speakers SP, or it may be shared with speakers SP disposed in the vehicle's audio system.

The vehicle active noise control system according to an exemplary embodiment of the present disclosure includes: a provisional virtual microphone path model H₁′(z) modeling a path from a specific error microphone EM_P, which is one of normal error microphones EM located around an abnormal error microphone EM_W, to a target position TP, which is a virtual microphone position corresponding to the abnormal error microphone EM_W; and a control unit 1 configured to generate control sound for a virtual microphone corresponding to the abnormal error microphone EM_W by use of the signal of the specific error microphone EM_P and the provisional virtual microphone path model H₁′(z), based on determination that the abnormal error microphone EM_W is abnormal.

That is, the vehicle active noise control system according to an exemplary embodiment of the present disclosure is configured so that when an error microphone EM is determined to be abnormal due to a malfunction, it selects one of the normal error microphones EM around the abnormal error microphone EM_W as the specific error microphone EM_P, and includes the specific error microphone EM_P substitute for the abnormal error microphone EM_W, continuously performing the active noise cancellation function.

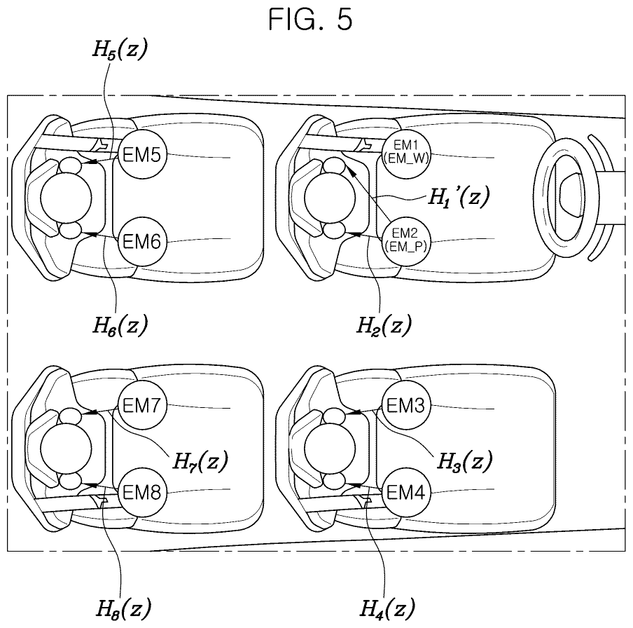

For example, as shown in FIG. 5, if a malfunction occurs in the left error microphone EM among the two left and right error microphones EM disposed in the driver's seat, the left error microphone EM becomes the abnormal error microphone EM_W, and the right error microphone EM becomes the specific error microphone EM_P. The vehicle active noise control system that was using the left error microphone EM is configured to continuously perform the active noise cancellation function using the right error microphone EM.

For reference, in FIG. 1, the control unit 1 is represented as a DSP and includes a storage unit 3 that stores the provisional virtual microphone path model H₁′(z).

The control unit 1 may be implemented as various electronic circuit devices other than a DSP, and the storage unit 3 may be configured as a non-volatile memory disposed in the DSP or a memory connected externally to the DSP.

Also, while the present exemplary embodiment exemplifies a case where the error microphone EM1 on the left side of the driver's seat is malfunctioning, it is not limited to this and the content of the present disclosure may be applied in the same way to all error microphones EM.

The control unit 1 is configured to replace an actual secondary path model Ŝ₁(z) modeling a path from a speaker SP to the abnormal error microphone EM_W with a borrowed secondary path model Ŝ₂(z), which is an actual secondary path model generated by modeling a path from the speaker SP to the specific error microphone EM_P, based on determination that the abnormal error microphone EM_W is abnormal.

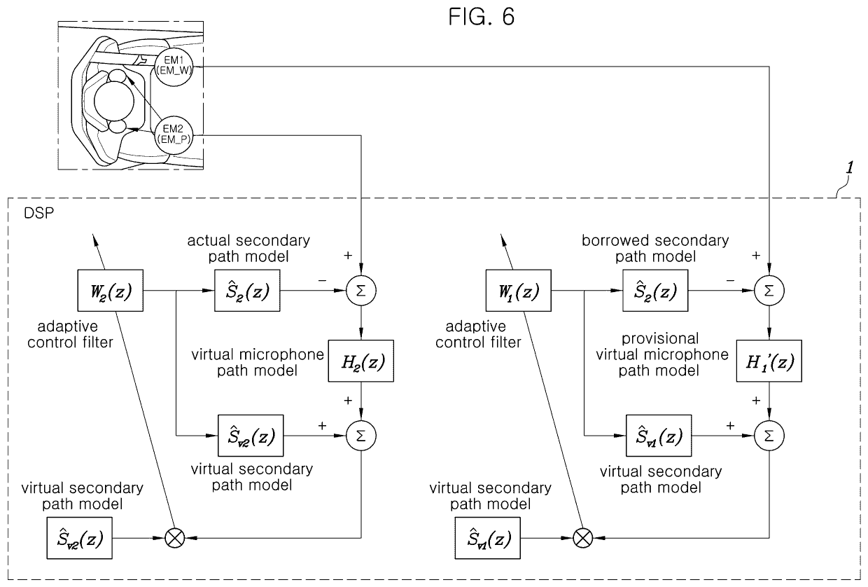

That is, as exemplified in FIG. 6, the active noise control system for the left ear of the occupant, unlike the normal state as shown in FIG. 4, is configured by replacing the actual secondary path model for the left error microphone EM with the actual secondary path model Ŝ₂(z) for the right error microphone EM.

Therefore, the estimated primary noise signal at the position of the specific error microphone EM_P is generated by subtracting the estimated control sound signal at the position of the specific error microphone EM_P, which is generated by applying the control sound signal provided to the speaker SP to the borrowed secondary path model Ŝ₂(z), from the signal of the specific error microphone EM_P.

The estimated primary noise signal at the position of the specific error microphone EM_P is transformed into an estimated primary noise signal at the target position TP by applying it to the provisional virtual microphone path model H₁′(z).

Additionally, the estimated error signal at the target position TP is generated by use of the estimated primary noise signal at the target position TP and the control sound signal at the target position TP.

At the present time, the control sound signal at the target position TP is generated by applying the control sound signal provided to the speaker SP to a virtual secondary path model Ŝᵥ₁(z) modeling a path from the speaker SP to the target position TP.

Therefore, the control sound signal provided to the speaker SP is generated by an adaptive control filter W₁(z) using a reference signal for the noise source, a signal obtained by applying the reference signal to the virtual secondary path model Ŝᵥ₁(z), and the estimated error signal at the target position TP.

Here, the reference signal for the noise source may be a signal from an accelerometer G disposed on the vehicle body or a separate microphone.

In the exemplary embodiment of the present disclosure, the specific error microphone EM_P is a normally operating error microphone EM, which forms a pair with the abnormal error microphone EM_W, and is one of error microphones EM respectively disposed around both ears of the same occupant.

That is, the specific error microphone EM_P may be selected among several other normal error microphones EM around the abnormal error microphone EM_W, but if one of the two error microphones EM disposed on both sides of the same occupant's ears is the abnormal error microphone EM_W, the specific error microphone EM_P may be selected as the other side error microphone EM that forms a pair with the abnormal error microphone EM.

As described above, according to an exemplary embodiment of the present disclosure, even when some of the numerous error microphones EM provided in the vehicle malfunction, the noise reduction function may be continuously implemented by utilizing the remaining normal error microphones EM, enhancing the marketability of the vehicle.

Furthermore, according to an exemplary embodiment of the present disclosure, the effect of not consuming excessive costs and time for maintenance, such as disassembling the entire headlining to repair when one or two error microphones EM malfunction, can also be achieved.

The present disclosure described above may also be expressed as follows.

That is, the vehicle active noise control method according to an exemplary embodiment of the present disclosure includes: monitoring an abnormality status of an error microphone EM in step S10; determining, in step S20, based on determination that an error microphone EM is abnormal, whether a provisional virtual microphone path model exists, the provisional virtual microphone path model generated by modeling a path from a specific error microphone EM_P, which is one of normal error microphones EM located around the abnormal error microphone EM_W, to a target position TP, which is a virtual microphone position corresponding to the abnormal error microphone EM_W; and generating, in step S30, control sound for a virtual microphone corresponding to the abnormal error microphone EM_W by use of the signal of the specific error microphone EM_P and the provisional virtual microphone path model, based on existence of the provisional virtual microphone path model.

The generating of the control sound for the virtual microphone corresponding to the abnormal error microphone EM_W in step S30 may include: generating an estimated primary noise signal at a position of the specific error microphone EM_P by use of the signal of the specific error microphone EM_P that substitutes for the abnormal error microphone EM_W; generating an estimated primary noise signal at the target position TP by use of the estimated primary noise signal at the position of the specific error microphone EM_P; generating an estimated error signal at the target position TP by use of the estimated primary noise signal at the target position TP; and generating a control sound signal provided to a speaker SP through the adaptive control filter by use of the estimated error signal at the target position TP.

The system may generate an estimated control sound signal at the position of the specific error microphone EM_P by applying a control sound signal provided to the speaker SP to a borrowed secondary path model, which is an actual secondary path model generated by modeling a path from the speaker SP to the specific error microphone EM_P.

The system may be configured to generate the estimated primary noise signal at the position of the specific error microphone EM_P by use of the estimated control sound signal and the signal of the specific error microphone EM_P.

The estimated primary noise signal at the target position TP may be generated by applying the estimated primary noise signal at the position of the specific error microphone EM_P to the provisional virtual microphone path model.

The estimated error signal at the target position TP may be generated by use of the estimated primary noise signal at the target position TP and a control sound signal at the target position TP.

The control sound signal at the target position TP may be generated by applying a control sound signal provided to the speaker SP to a virtual secondary path model generated by modeling a path from the speaker SP to the target position TP.

The control sound signal provided to the speaker SP may be generated by an adaptive control filter using a reference signal for a noise source, a signal obtained by applying the reference signal to the virtual secondary path model, and the estimated error signal at the target position TP.

Although specific embodiments of the present disclosure have been described, it will be apparent to those skilled in the art that various modifications and variations may be made without departing from the scope and spirit of the present disclosure as defined by the appended claims.

What is claimed is:

1. A vehicle active noise control system comprising:
a provisional virtual microphone path model generated by modeling a path from a specific error microphone, which is one of normal error microphones located around an abnormal error microphone, to a target position, which is a virtual microphone position corresponding to the abnormal error microphone;
a controller generating a control sound for a virtual microphone corresponding to the abnormal error microphone by use of a signal of the specific error microphone and the provisional virtual microphone path model, based on determination that the abnormal error microphone is abnormal.

2. The vehicle active noise control system of claim 1, wherein the controller replaces an actual secondary path model generated by modeling a path from a speaker to the abnormal error microphone with a borrowed secondary path model, which is an actual secondary path model generated by modeling a path from the speaker to the specific error microphone, based on the determination that the abnormal error microphone is abnormal.

3. The vehicle active noise control system of claim 2, wherein the controller generates an estimated primary noise signal at a position of the specific error microphone by use of the signal of the specific error microphone and an estimated control sound signal generated by applying a control sound signal provided to the speaker to the borrowed secondary path model.

4. The vehicle active noise control system of claim 3, wherein the controller transforms the estimated primary noise signal at the position of the specific error microphone into an estimated primary noise signal at the target position by applying the estimated primary noise signal at the position of the specific error microphone to the provisional virtual microphone path model.

5. The vehicle active noise control system of claim 4, wherein the controller generates an estimated error signal at the target position by use of the estimated primary noise signal at the target position and a control sound signal at the target position.

6. The vehicle active noise control system of claim 5, wherein the control sound signal at the target position is generated by applying a control sound signal provided to the speaker to a virtual secondary path model generated by modeling a path from the speaker to the target position.

7. The vehicle active noise control system of claim 6, wherein the control sound signal provided to the speaker to be generated by an adaptive control filter using a reference signal for a noise source, a signal obtained by applying the reference signal to the virtual secondary path model, and the estimated error signal at the target position.

8. The vehicle active noise control system of claim 7, wherein the reference signal for the noise source is a signal from an accelerometer disposed on a vehicle body of a vehicle.

9. The vehicle active noise control system of claim 1, wherein the specific error microphone is a normally operating error microphone, which forms a pair with the abnormal error microphone, and is one of error microphones respectively disposed around both ears of the same occupant.

10. The vehicle active noise control system of claim 1, further comprising:
a storage unit storing the provisional virtual microphone path model.

11. A vehicle active noise control method comprising:
monitoring, by a controller, an abnormality status of an error microphone;
determining, by the controller, based on determination that an error microphone is abnormal, whether a provisional virtual microphone path model exists, the provisional virtual microphone path model generated by modeling a path from a specific error microphone, which is one of normal error microphones located around the abnormal error microphone, to a target position, which is a virtual microphone position corresponding to the abnormal error microphone; and
generating, by the controller, a control sound for a virtual microphone corresponding to the abnormal error microphone by use of a signal of the specific error microphone and the provisional virtual microphone path model, based on existence of the provisional virtual microphone path model.

12. The vehicle active noise control method of claim 11, wherein the generating of the control sound for the virtual microphone corresponding to the abnormal error microphone comprises:
generating an estimated primary noise signal at a position of the specific error microphone by use of the signal of the specific error microphone;
generating an estimated primary noise signal at the target position by use of the estimated primary noise signal at the position of the specific error microphone;
generating an estimated error signal at the target position by use of the estimated primary noise signal at the target position; and
generating a control sound signal provided to a speaker through the adaptive control filter by use of the estimated error signal at the target position.

13. The vehicle active noise control method of claim 12, further comprising:
generating, by the controller, an estimated control sound signal at the position of the specific error microphone by applying a control sound signal provided to the speaker to a borrowed secondary path model, which is an actual secondary path model generated by modeling a path from the speaker to the specific error microphone; and
generating, by the controller, the estimated primary noise signal at the position of the specific error microphone by use of the estimated control sound signal and the signal of the specific error microphone.

14. The vehicle active noise control method of claim 12, wherein the estimated primary noise signal at the target position is generated by applying the estimated primary noise signal at the position of the specific error microphone to the provisional virtual microphone path model.

15. The vehicle active noise control method of claim 12, wherein the estimated error signal at the target position is generated by use of the estimated primary noise signal at the target position and a control sound signal at the target position.

16. The vehicle active noise control method of claim 15, wherein the control sound signal at the target position is generated by applying a control sound signal provided to the speaker to a virtual secondary path model generated by modeling a path from the speaker to the target position.

17. The vehicle active noise control method of claim 16, wherein the control sound signal provided to the speaker is generated by an adaptive control filter using a reference signal for a noise source, a signal obtained by applying the reference signal to the virtual secondary path model, and the estimated error signal at the target position.

18. The vehicle active noise control method of claim 11, wherein the specific error microphone is a normally operating error microphone, which forms a pair with the abnormal error microphone, and is one of error microphones respectively disposed around both ears of the same occupant.

19. A vehicle comprising the vehicle active noise control system of claim 1.
